(19) United States
(12) Patent Application Publication
(10) Pub. No.: US 2010/0075672 A1
(43) Pub. Date: Mar. 25, 2010

(54) MULTIPLE ANTENNA WIRELESS COMMUNICATION SYSTEM WHICH ADAPTIVELY DETERMINES DOWNLINK TRANSMISSION MODE

(75) Inventors: Hye Kyung JWA, Daejeon (KR); Il Gyu KIM, Okcheon-Gun (KR); Hyun Kyu CHUNG, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/543,560

(22) Filed: Aug. 19, 2009

(30) Foreign Application Priority Data
Sep. 25, 2008 (KR) 10-2008-0094079

(51) Int. Cl. H04W 40/06

(52) U.S. Cl. 455/434

(57) ABSTRACT

An operation method of a base station which adaptively determines a downlink transmission mode is provided. The operation method of the base station including: adaptively determining a downlink transmission mode based on at least one of a state of a channel between the base station and a terminal, and a number of receiving antennas, the number of receiving antennas being at least one and the receiving antennas being mounted on the terminal; selecting one of at least one type of feedback information which is fed back by the terminal based on the determined downlink transmission mode; and reporting type information associated with the selected type to the terminal.

### CROSS-REFERENCE TO RELATED APPLICATION

This application claims priority from Korean Patent Application No. 10-2008-0094079, filed on Sep. 25, 2008, in the Korean Intellectual Property Office, the entire disclosure of which is incorporated herein by reference.

### BACKGROUND OF THE INVENTION

1. Field of the Invention

The present invention relates to a multiple antenna wireless communication system, and more particularly, to a technology that adaptively determines a downlink transmission mode.

2. Description of Related Art

Currently, much research has been actively conducted to provide a variety of multimedia services such as a voice service, and support a high quality and high-speed data transmission in a wireless communication environment. Technologies related to a multiple antenna wireless communication system such as a Multiple Input Multiple Output (MIMO) communication system have been developed as part of the research.

A base station may perform downlink communication using various transmission modes in a multiple antenna wireless communication system. In this instance, transmission modes may be divided into a transmit diversity mode, an Open-Loop Multiple Input Multiple Output (OL MIMO), and a Closed-Loop MIMO (CL MIMO) based on the number of pieces of data transmitted through multiple antennas.

A base station may obtain a transmission diversity by transmitting a single piece of data through multiple antennas in a transmit diversity mode. In particular, a base station may use a Space Time Block Code (STBC), and the like in a transmit diversity mode.

In an OL MIMO or a CL MIMO, a base station may transmit at least two pieces of data through multiple antennas, and terminals may appropriately distinguish the data. Accordingly, a data rate may be improved in proportion to the number of multiple antennas.

The number of pieces of data transmitted through multiple antennas of a base station may correspond to a rank. In this instance, the rank may be limited by the number of transmission antennas of the base station and the number of receiving antennas of a terminal. That is, a maximum rank may be the smallest value of the number of transmission antennas of a base station and the number of receiving antennas of a terminal.

In this instance, a transmission mode used in the base station may be appropriately determined based on a rank or a state of a channel between the base station and the terminal. Also, appropriate feedback information is required to be provided to the base station for better use of the determined transmission mode.

### SUMMARY OF THE INVENTION

According to example embodiments, a base station may adaptively determine a downlink transmission mode based on a rank or a channel state, and thereby may maximize a data rate.

Also, according to example embodiments, a base station may appropriately select a type of feedback information based on a determined downlink transmission mode, and thereby may improve a throughput.

Also, according to example embodiments, a terminal may generate feedback information based on a selected type of feedback information, and thereby may appropriately support a downlink communication of a base station.

According to an aspect of the present invention, there is provided an operation method of a base station which adaptively determines a downlink transmission mode, the operation method including: adaptively determining a downlink transmission mode based on at least one of a state of a channel between the base station and a terminal, and a number of receiving antennas, the number of receiving antennas being at least one and the receiving antennas being mounted on the terminal; selecting one of at least one type of feedback information which is fed back by the terminal based on the determined downlink transmission mode; and reporting type information associated with the selected type to the terminal.

According to an aspect of the present invention, there is provided an operation method of a terminal, the operation method including: receiving type information associated with a type of feedback information, the type of the feedback information being determined based on a downlink transmission mode; and generating the feedback information based on the type information.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a diagram illustrating operations of a terminal and a base station according to example embodiments;

FIG. 2 is a flowchart illustrating an operation method of a base station which adaptively determines a downlink transmission mode according to example embodiments;

FIG. 3 is a diagram illustrating types of feedback information according to example embodiments;

FIG. 4 is a block diagram illustrating a terminal according to example embodiments; and

FIG. 5 is a flowchart illustrating an operation method of a terminal according to example embodiments.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

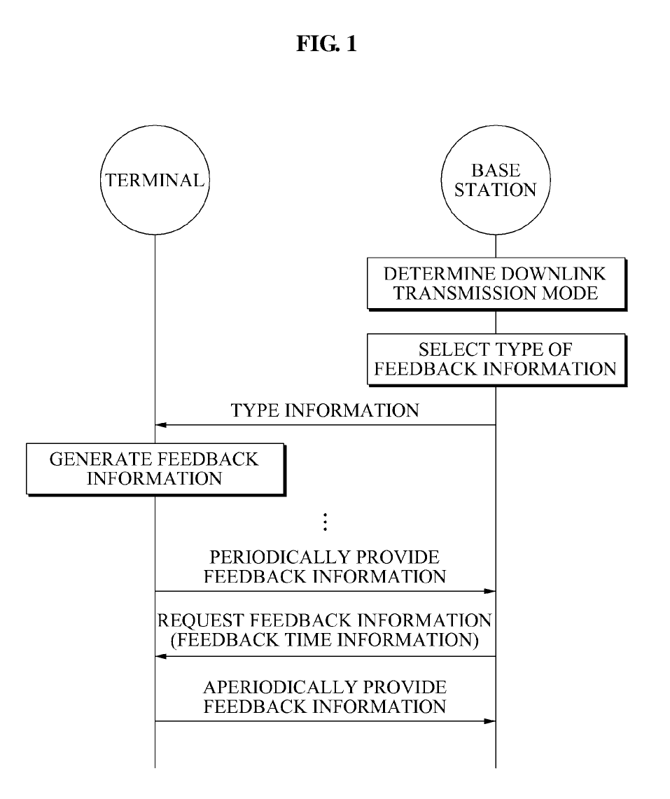

FIG. 1 is a diagram illustrating operations of a terminal and a base station according to example embodiments.

Referring to FIG. 1, the base station may determine a downlink transmission mode based on at least one of a number of receiving antennas of a terminal, a state of a channel between the terminal and the base station, and a rank. In this instance, the downlink transmission mode may be determined as any one of a transmit diversity mode, an Open-Loop Multiple Input Multiple Output (OL MIMO) mode, and a Closed-Loop MIMO (CL MIMO) mode. In particular, when feedback information, which is required when the base station determines the downlink transmission mode, does not exist, the base station may request the feedback information required for the determination of the downlink transmission mode from the terminal.

Also, the base station may select one of a plurality of types of the feedback information based on the determined downlink transmission mode. Here, the feedback information may include at least one of a channel quality indicator (CQI), a preceding matrix indicator (PMI), and a rank indicator. The plurality of types of the feedback information may be distinguished based on at least one of whether the feedback information includes the PMI, whether the CQI is associated with an entire frequency band, and whether the PMI is associated with the entire frequency band.

The base station may report type information associated with the selected type to the terminal. In this instance, the terminal may generate feedback information based on the type information, and periodically provide the base station with the generated feedback information.

Also, the base station may provide feedback time information to the terminal. The feedback time information may be associated with a time when the terminal feeds back the feedback information of the selected type to the base station. In this instance, the feedback time information may include information about whether the terminal reports the feedback information to the base station periodically or aperiodically.

When the feedback time information may include information where the terminal is to aperiodically report the feedback information to the base station, the terminal may aperiodically provide the feedback information to the base station. Particularly, the base station may command that the terminal immediately provide the feedback information to the base station, using the feedback time information.

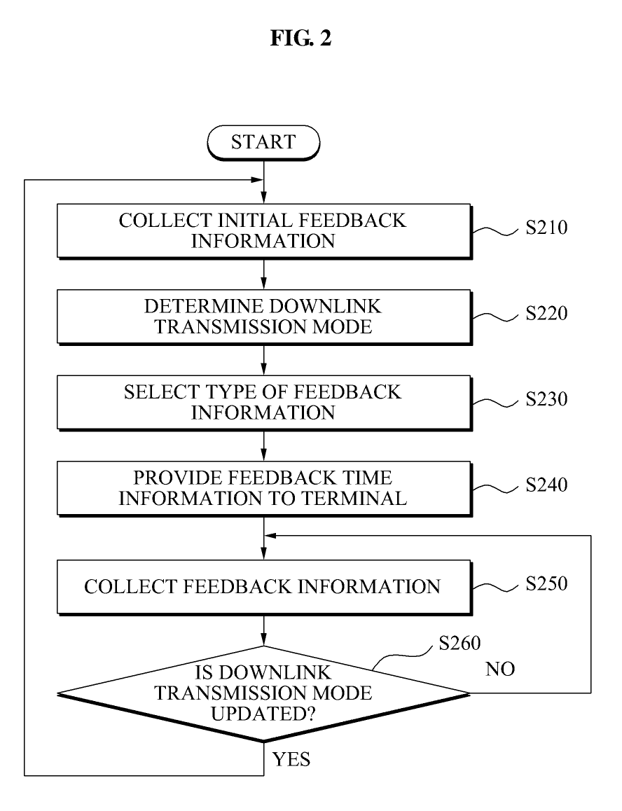

FIG. 2 is a flowchart illustrating an operation method of a base station which adaptively determines a downlink transmission mode according to example embodiments.

Referring to FIG. 2, in operation S210, the base station may collect initial feedback information to determine the downlink transmission mode. In particular, the base station may appropriately use feedback information, previously provided by a terminal, as the initial feedback information. Also, the base station may request that the terminal immediately provides the feedback information using feedback time information.

In operation S220, the base station may adaptively determine the downlink transmission mode using the collected initial feedback information. In this instance, the base station may determine the downlink transmission mode based on the initial feedback information to enable a sum data rate to be maximized.

For example, when a single receiving antenna of the terminal exists, the base station may determine a transmit diversity mode as the downlink transmission mode. In this instance, when a number of transmission antennas of the base station is greater than one and a number of receiving antennas is one, a maximum rank may be one. Also, when the number of receiving antennas of the terminal is equal to or greater than two, and a state of a channel is appropriate for a MIMO mode, the base station may determine any one of the CL MIMO mode and the OL MIMO mode as the downlink transmission mode. However, when the number of receiving antennas of the terminal is one, the base station may determine a rank 1 CL MIMO mode as the downlink transmission mode.

In operation S230, the base station may select a type of feedback information based on the determined downlink transmission mode.

For example, when the transmit diversity mode is determined as the downlink transmission mode, the type of the feedback information may be determined to enable the feedback information to include a CQI without a PMI.

Also, when the CL MIMO mode is determined as the downlink transmission mode, the type of the feedback information may be determined to enable the feedback information to include the CQI and the PMI, and to enable a rank indicator to be set as information as opposed the rank indicator being set to one. Also, when the OL MIMO mode is determined as the downlink transmission mode, the type of the feedback information may be determined to prevent the feedback information from including the PMI.

In operation S240, the base station may provide feedback time information to the terminal. The terminal may ascertain whether to provide the base station with the feedback information periodically or aperiodically, using the feedback time information. Also, the terminal may provide the base station with the feedback information based on the feedback time information.

In operation S250, the base station may collect the feedback information provided by the terminal.

In operation S260, the base station may determine whether to update the downlink transmission mode based on the collected feedback information. When the downlink transmission mode is updated, the base station may return to operation S210. When the downlink transmission mode is not updated, the base station may return to operation S250.

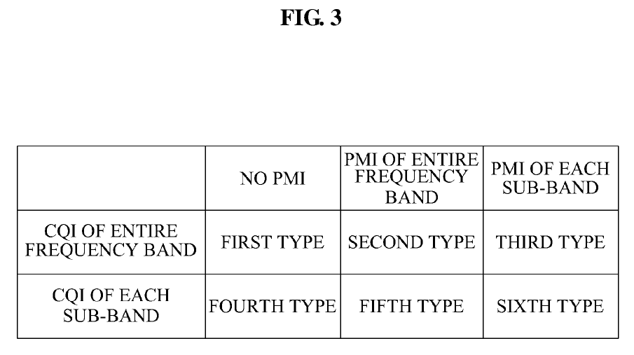

FIG. 3 is a diagram illustrating types of feedback information according to example embodiments.

Referring to FIG. 3, the types of the feedback information may be distinguished based on at least one of whether the feedback information includes a PMI, whether a CQI is associated with an entire frequency band, and whether the PMI is associated with the entire frequency band. Here, it may be assumed that a rank indicator has a single value with respect to the entire frequency band.

When any one of a transmit diversity mode and a CL MIMO mode is determined as a downlink transmission mode, the feedback information may have a first type or a fourth type. That is, the feedback information of the first type and the fourth type may not include the PMI.

Also, the CQI may be calculated with respect to the entire frequency band or each sub-band of the entire frequency band. That is, when the CQI is calculated with respect to the entire frequency band, the feedback information may have the first type, a second type, or a third type. When the CQI is calculated with respect to each of the sub-bands, the feedback information may have the fourth type, a fifth type, or a sixth type.

Similarly, when the PMI is calculated with respect to the entire frequency band, the feedback information may have the second type or the fifth type. When the PMI is calculated with respect to each of the sub-bands, the feedback information may have the third type or the sixth type.

Accordingly, the base station may select any one from the first through sixth types, and thus a type, appropriate for the determined downlink transmission mode, may be determined.

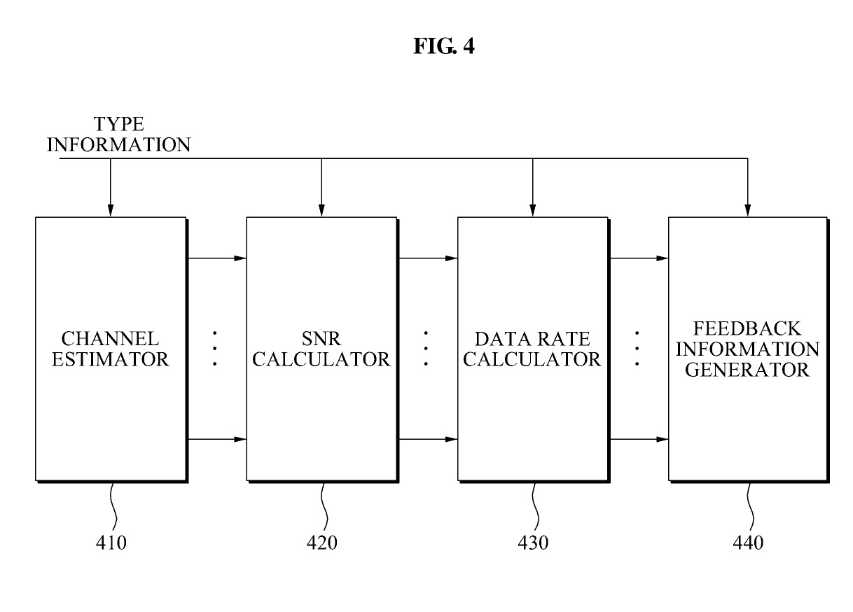

FIG. 4 is a block diagram illustrating a terminal according to example embodiments.

Referring to FIG. 4, the terminal may include a channel estimator 410, a Signal to Noise Ratio (SNR) calculator 420, a data rate calculator 430, and a feedback information generator 440.

The channel estimator 410 may estimate a channel formed between the terminal and a base station using a reference signal such as a received pilot signal.

The SNR calculator 420 may calculate an SNR of a received signal based on the estimated channel. The data rate calculator 430 may calculate a data rate using the calculated SNR.

The feedback information generator 440 may generate feedback information based on the calculated data rate and type information. The feedback information may include at least one of a CQI, a PMI, and a rank indicator. That is, the feedback information generator 440 may generate the feedback information to enable a sum data rate to be maximized based on a determined type of feedback information.

For example, it may be assumed that a transmit diversity mode is determined as a downlink transmission mode and a first type is determined as the type of the feedback information. In this instance, the terminal may generate feedback information including a CQI with respect to an entire frequency band. Also, the terminal may provide the base station with feedback information including the CQI and a rank indicator indicating a rank 1. Also, the terminal may provide the base station with feedback information including a rank indicator indicating a rank 2 or a rank higher than 2. In this instance, the base station may change the downlink transmission mode from the transmit diversity mode to an OL MIMO mode.

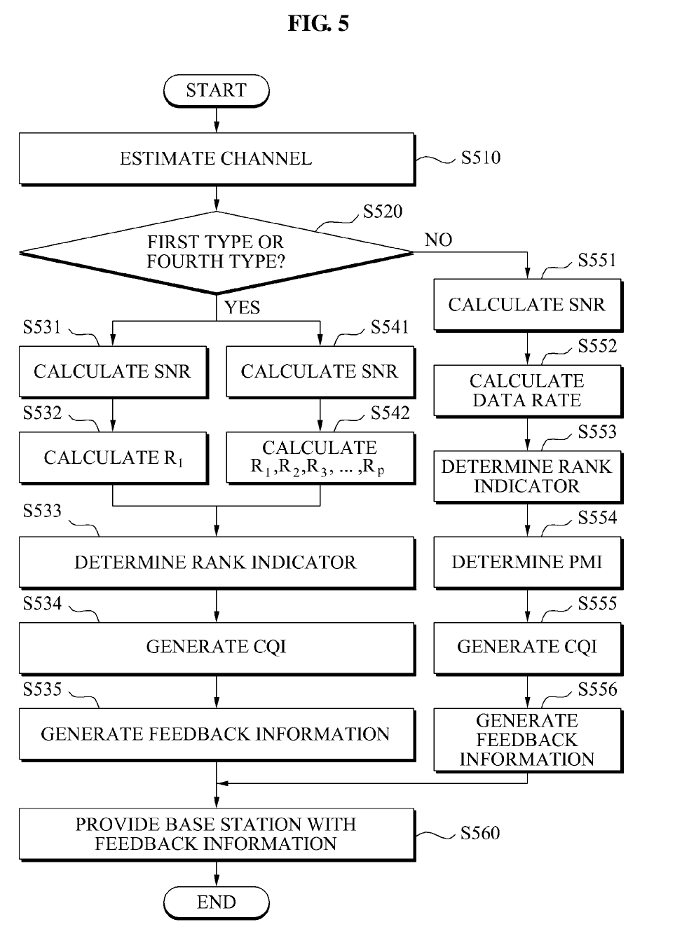

FIG. 5 is a flowchart illustrating an operation method of a terminal according to example embodiments.

Referring to FIG. 5, in operation S510, the terminal may estimate a channel formed between the terminal and a base station. Here, a capacity of the estimated channel may be associated with a CQI, and a direction of the estimated channel may be associated with a PMI.

In operation S520, the terminal may determine a selected type of feedback information. That is, the terminal may determine whether the selected type of the feedback information is a first type or a fourth type, and thereby may determine whether the feedback information is to include the PMI.

When the selected type of the feedback information is the first type or the fourth type, the terminal may generate feedback information including a rank indicator and a CQI, since the feedback information does not include the PMI. In this instance, the rank indicator may have a value equal to or greater than one.

The terminal may determine the rank indicator to enable a sum data rate to be maximized based on each of a transmit diversity mode and an OL MIMO mode. Also, the terminal may generate the feedback information including the rank indicator and the CQI corresponding to the type of the feedback information.

That is, in operation S531, the terminal may assume that the transmit diversity mode is a downlink transmission mode, and calculate an SNR of a receiving signal in the transmit diversity mode. In operation S532, since a rank is one(1) in the transmit diversity mode, the terminal may calculate a data rate R₁ with respect to the rank 1 based on the calculated SNR.

Here, a maximum rank may be limited by a number of transmission antennas of the base station or a number of receiving antennas of the terminal. That is, when the number of transmission antennas of the base station is greater than the number of receiving antennas of the terminal, and the number of receiving antennas is P, the maximum rank may be P.

Also, the terminal may assume that the OL MIMO mode is the downlink transmission mode. That is, when the type of the feedback information is the first type or the fourth type, the terminal may calculate an SNR of a receiving signal in the OL MIMO mode in operation S541.

A rank may be any one of one, two, three, . . . , and P in the OL MIMO mode. Accordingly, the terminal may calculate a data rate (R₁, R₂, R₃, . . . , and R_{P}) with respect to the rank (one, two, three, . . . , and P) in operation S542.

In operation S533, the terminal may determine a rank indicator based on the data rate R₁, calculated in operation S532, and the data rate (R₁, R₂, R₃, . . . , and R_{P}) calculated in operation S542. That is, the terminal may select a rank corresponding to a greatest value from the calculated data rate R₁ and the calculated data rate (R₁, R₂, R₃, . . . , and R_{P}), and thereby may determine the selected rank as the rank indicator.

In operation S534, the terminal may generate a CQI with respect to an entire frequency band or each sub-band. In operation S535, the terminal may generate feedback information including the generated CQI and the determined rank indicator.

In operation S560, the generated feedback information may be provided to the base station.

Also, when the type of the feedback information is not the first type or the fourth type, the type of the feedback information may be any one of a second type, a third type, a fifth type, and a sixth type, and the feedback information may include a PMI. That is, when the type of the feedback information is any one of the second type, the third type, the fifth type, and the sixth type, a CL MIMO mode may be the downlink transmission mode. In operation S551, the terminal may virtually apply an available rank and an available preceding matrix, and thereby may calculate an SNR of a receiving signal.

In operation S552, the terminal may calculate a data rate with respect to ranks that may be precoded and available preceding matrices. In operation S553, the terminal may determine a rank corresponding to a maximum data rate as a rank indicator. In operation S554, the terminal may determine an index of a preceding matrix corresponding to the maximum data rate with respect to the determined rank indicator, as the PMI.

In operation S555, the terminal may generate a CQI with respect to each of an entire frequency band and each sub-band. In operation S556, the terminal may generate feedback information including the rank indicator, the PMI, and the CQI.

In operation S560, the feedback information, generated in any one operation of operation S534, S544 and operation S546, may be provided to the base station.

Also, the base station may transfer the feedback information, particularly, the CQI, to a scheduler of a Media Access Control (MAC) sub-layer. The scheduler may allocate resources for downlink communication of the base station.

The operation method of a terminal and the operation method of a base station according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An operation method of a base station which adaptively determines a downlink transmission mode, the operation method comprising:
adaptively determining a downlink transmission mode based on at least one of a state of a channel between the base station and a terminal, and a number of receiving antennas, the number of receiving antennas being at least one and the receiving antennas being mounted on the terminal;
selecting one of at least one type of feedback information which is fed back by the terminal based on the determined downlink transmission mode; and
reporting type information associated with the selected type to the terminal.

2. The operation method of claim 1, further comprising:
providing, to the terminal, feedback time information associated with a time when the terminal feeds back the feedback information of the selected type to the base station.

3. The operation method of claim 1, further comprising:
updating the determined downlink transmission mode based on the feedback information of the selected type.

4. The operation method of claim 1, wherein the feedback information includes at least one of a channel quality indicator (CQI), a preceding matrix indicator (PMI), and a rank indicator.

5. The operation method of claim 1, wherein the feedback information includes at least one of a CQI and a PMI, and the at least one type of the feedback information is distinguished based on at least one of whether the feedback information includes the PMI, whether the CQI is associated with an entire frequency band, and whether the PMI is associated with the entire frequency band.

6. The operation method of claim 1, wherein the at least one type of the feedback information includes at least one of a first type, a second type, and a third type,
the feedback information of the first type includes a CQI with respect to an entire frequency band,
the feedback information of the second type includes the CQI with respect to the entire frequency band and a PMI with respect to the entire frequency band, and
the feedback information of the third type includes the CQI with respect to the entire frequency band and the PMI with respect to each sub-band of the entire frequency band.

7. The operation method of claim 1, wherein the at least one type of the feedback information includes at least one of a fourth type, a fifth type, and a sixth type,
the feedback information of the fourth type includes a CQI with respect to each sub-band of an entire frequency band and a PMI with respect to the entire frequency band,
the feedback information of the fifth type includes the CQI with respect to each of the sub-bands of the entire frequency band and the PMI with respect to the entire frequency band, and
the feedback information of the sixth type includes the CQI with respect to each of the sub-bands of the entire frequency band and the PMI with respect to each of the sub-bands of the entire frequency band.

8. The operation method of claim 1, wherein the determining of the downlink transmission mode determines any one of a transmit diversity mode to obtain a diversity gain, an Open-Loop Multiple Input Multiple Output (OL MIMO) mode, and a Closed-Loop MIMO (CL MIMO) mode to be applied when the number of receiving antennas is at least two.

9. The operation method of claim 1, wherein the determining of the downlink transmission mode determines the downlink transmission mode to enable a sum data rate of the base station to be maximized.

10. The operation method of claim 1, wherein the terminal feeds back the feedback information of the selected type to the base station using the type information.

11. An operation method of a terminal, the operation method comprising:
receiving type information associated with a type of feedback information, the type of the feedback information being determined based on a downlink transmission mode; and
generating the feedback information based on the type information.

12. The operation method of claim 11, wherein the determined type of the feedback information is any one of a plurality of types of the feedback information, and
the plurality of types of the feedback information are distinguished based on at least one of whether the feedback information includes a PMI, whether a CQI is associated with an entire frequency band, and whether the PMI is associated with the entire frequency band.

13. The operation method of claim 11, further comprising:
receiving feedback time information associated with a time to feed back the generated feedback information of the selected type to the base station; and
feeding back the generated feedback information to the base station based on the received feedback time information.

14. The operation method of claim 11, wherein the feedback information includes at least one of a CQI, a PMI, and a rank indicator, and the generating determines the at least one of the CQI, the PMI, and the rank indicator to enable a sum data rate to be maximized, the sum data rate being predicted depending on a channel between the base station and the terminal.

15. The operation method of claim 11, wherein the downlink transmission mode is determined based on at least one of a state of a channel between the base station and the terminal and a number of receiving antennas, the number of receiving antennas being at least one and the receiving antennas being mounted on the terminal.

16. The operation method of claim 11, wherein the downlink transmission mode is any one of a transmit diversity mode to obtain a diversity gain, an OL MIMO mode, and a CL MIMO mode to be applied when the number of receiving antennas is at least two.
